(19) United States
(12) Patent Application Publication
(10) Pub. No.: US 2021/0048838 A1
(43) Pub. Date: Feb. 18, 2021

(54) Customizable joystick-based means for controlling the brake and throttle of a motor vehicle using a single hand

(71) Applicant: Hayden Miller Stipe, Spokane Valley, WA (US)

(72) Inventor: Hayden Miller Stipe, Spokane Valley, WA (US)

(21) Appl. No.: 16/540,072

(22) Filed: Aug. 14, 2019

(51) Int. Cl. G05G 9/02; B60K 26/02; B60T 7/08

(52) U.S. Cl. CPC G05G 9/02; B60K 2026/029; B60T 7/085; B60K 26/02

(57) ABSTRACT

A joystick-based hand control device establishes a method for an individual with a lower extremity mobility impairment to safely operate the brake and throttle in a car using only a single hand to manipulate said joystick (2). This device allows the operator to control the throttle by moving the joystick along the positive y-axis (3) (forwards from center). The brake may be controlled by moving the joystick along the negative y-axis (backwards from center), as well as along the x-axis (left or right from center) (5 and 6 respectively). This device also allows for customization of certain system parameters by the operator via the microcontroller (7), so that its function may be modified to better suit the operator's unique needs or driving style.

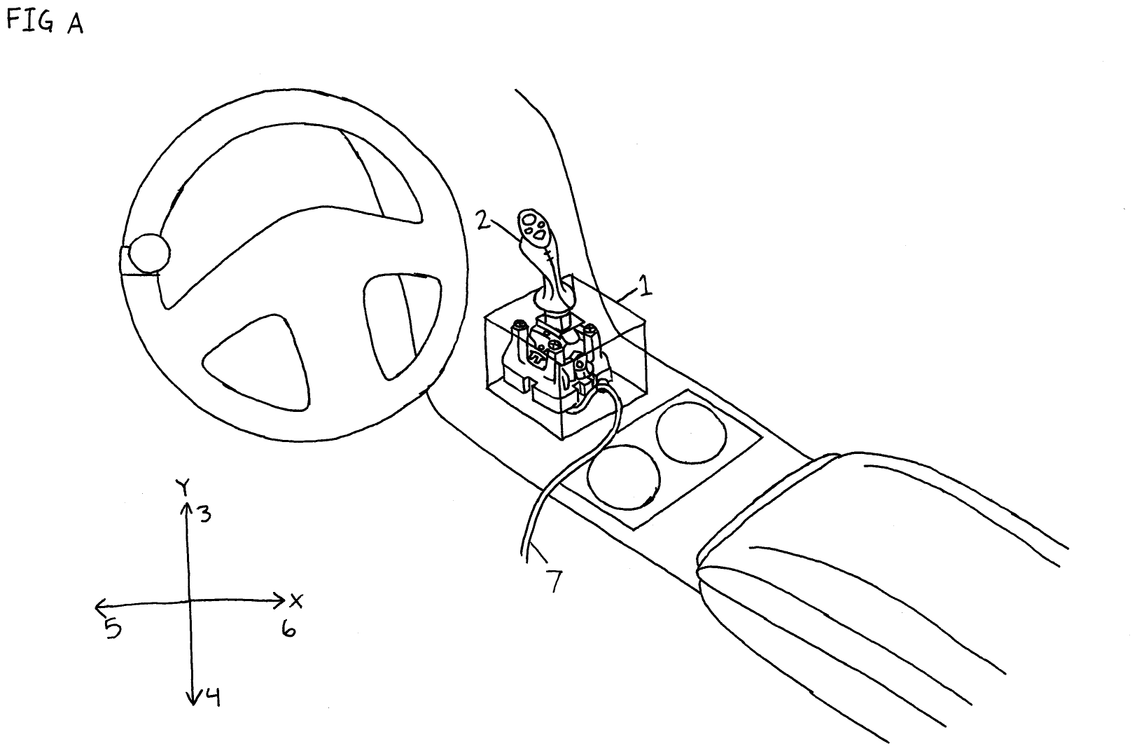

### II. BACKGROUND INFORMATION

Individuals with medical conditions that limit the use of their lower extremities cannot drive a motor vehicle using the traditional throttle and brake pedals. Instead these individuals must seek the aid of assistive devices that make it possible to actuate the pedals using the upper extremities. For the purposes of this document, such devices will henceforth be referred to simply as “hand controls” or “hand control system”. Also, for the purposes of this application the words “user” and “operator” are used interchangeably, as are the phrases “microcontroller” and “central electronic system”.

### III. DESCRIPTION OF PRIOR ART

Hand control technology has been around for decades, utilizing the same mechanical lever system as is illustrated by HVL 1. This system functions by way of metal rods attached to the throttle and brake pedals respectively and manipulated by a single lever. The direction in which the user pushes the lever determines which pedal is actuated.

Systems of this type come in multiple variations, the chief difference between each being the position and orientation of the lever. The appropriate variation is chosen based upon the handedness and preference of the user. These are the only two aspects of these systems that may be varied to suit the user. This severely limits the potential market for this style of hand control, and greatly disadvantages those that require more extensive accommodations in order to be able to drive

Other systems have been proposed to remedy this issue and offer more customization to the user, such as that of HVL 2. The system described by HVL 2 features a similar lever-based apparatus as HVL 1, but it introduces computerized components. These components eliminate the need for metal rods to be attached to the pedals in order for the device to function. These components can be programmed to vary the amount of force required to actuate the system, without regard for the resistance that is inherently present in the pedal itself. This is done without compromise to the performance of the device or the vehicle in which it is installed.

A third solution exists to attempt to provide what each of the previously described systems lack: the ability to adjust for differing ranges of motion in the arm, which can vary greatly amongst individuals with various physiological and neuromuscular conditions. This system, described in EMC, details an electronic system that uses a series of levers to allow the user to manipulate the brake and throttle. But this system again offers little opportunity to modify the functionality of the system, which presents a significant obstacle for the user to be able to safely operate their vehicle. The sheer size of the of this system also imposes a limit on the passenger capacity of the vehicle in which it is installed.

### V. SUMMARY OF PROPOSED INVENTION

An electronic driving aid comprising: a joystick, microcontroller, and an interface, which allows the user to operate the brake and throttle in a motor vehicle with only one hand. No use of lower extremities is required, and the system may be modified to fit the user's exact specifications.

### V. ADVANTAGES

Accordingly, several advantages of one or more aspects of the invention are as follows: to provide the user a means to operate the brake and throttle of a motor vehicle using a single hand, do so WITHOUT imposing a limit on the passenger capacity of the vehicle; an electronic microcontroller system permissive of reprogramming to make the invention more suitable to an individual user based on the effects of the movement-limiting disability that necessitated the usage of the invention.

### VI. DRAWING DESCRIPTION

FIG A:

Overview of proposed invention as it would be installed in the vehicle. A housing for the system comprised of a box made of plastic (1) contains the circuitry for the joystick mechanism and the primary microcontroller, which has a handle protruding out of the housing (2) that the user would grab in order to control the system. The throttle of the vehicle is controlled by moving the joystick forward from its home position, parallel to the y-axis (3). The brake is controlled by moving the joystick backwards from its home position, parallel to the y-axis (4). The brake may also be controlled by moving the joystick left (5) or right (6), parallel to the x-axis. These controls are adjustable as seen fit by the user. Wires (7) protrude from under the housing to allow the system to interface with the vehicle.

### VIIII. DETAILED DESCRIPTION OF INVENTION

The invention described in this application comprises a joystick with complete freedom of movement in both the x-axis (5 and 6) and y-axis (3 and 4); a programmable microcontroller (1); and a means for interfacing with the throttle and brake of the motor vehicle (7) in which the invention is installed, the specifics of said interface are not within the scope of this application.

The invention allows the user to control the throttle of the motor vehicle by moving the joystick in the positive direction along the y-axis (3). The motor vehicle's brake may be controlled by moving the joystick in the negative direction along the y-axis (4), as well as either direction along the x-axis (5 or 6).

When the user moves the joystick, information about its new position is communicated to the microcontroller (1). The microcontroller uses this information to calculate the position of the throttle or brake desired by the user. If the user's desired position differs from the actual position of the motor vehicle's throttle or brake, the microcontroller, in order to produce the desired effect on the motion of the motor vehicle, makes the necessary adjustments to the interface (7) using a predetermined algorithm.

I claim:

1. An electronic driving aid operable for controlling the brake and throttle of a motor vehicle without use of the operator's lower extremities comprising:
a. a joystick mechanism (1 and 2) with position sensing in both the x (3 and 4) and y axis (5 and 6) by which the operator may control the brake and throttle using a single hand
b. a central electronic system for processing information supplied by the joystick in order to determine the position of the x and y axis set by the operator
c. a means for data transfer between the joystick and central electronic system (7) described in preceding claims.

2. A means for the user to customize the central electronic system described in claim 1 characterized in that the system's responses to inputs from the joystick may be modified to be more appropriate for the operator's unique anatomical range of motion and/or speed of reaction

3. A programmatic means for the central electronic system to determine the desired position of the brake and throttle based on the position of the joystick described in claim 1 consisting of:
a. a mathematical equation relating the position of the joystick to the desired position of the brake and throttle
b. a function to calculate the difference between current position of the throttle or brake and the desired position set by the operator
